(19) United States
(12) Patent Application Publication
(10) Pub. No.: US 2020/0175462 A1
(43) Pub. Date: Jun. 4, 2020

(54) METHOD AND SYSTEM FOR TWO-ECHELON BALANCED INVENTORY ALLOCATION

(71) Applicants: Beijing Jingdong Shangke Information Technology Co, Ltd., Beijing (CN); JD.com American Technologies Corporation, Mountain View, CA (US)

(72) Inventors: Xiao Tan, Beijing (CN); Xin Wang, Beijing (CN); Rong Yuan, Mountain View, CA (US); Jie Lu, Mountain View, CA (US); Chenxin Ma, Mountain View, CA (US); Di Wu, Mountain View, CA (US); Chen Chen, Beijing (CN)

(21) Appl. No.: 16/211,754

(22) Filed: Dec. 6, 2018

Related U.S. Application Data
(63) Continuation-in-part of application No. 16/208,475, filed on Dec. 3, 2018.
Application No. 16/208,475 is a continuation-in-part of application No. 16/208,439, filed on Dec. 3, 2018.

(51) Int. Cl. G06Q 10/08; G06Q 10/06; G06Q 10/04

(52) U.S. Cl. CPC G06Q 10/087; G06Q 10/083; G06Q 10/04; G06Q 10/06315

(57) ABSTRACT

Systems and methods for allocating inventory between a first level distribution center and multiple second level distribution centers. The method includes: for each of the second level distribution centers: determining ideal replenishment levels of products based on current inventory and demand forecast for each of the products and transportation capacity limit of the second level distribution centers; for each of the products: determining actual replenishment levels in the second level distribution centers based on the ideal replenishment levels in the second level distribution centers, current available inventory of the product in the first level distribution center, current inventories and demand forecasts in the second level distribution centers, and priority of the second level distribution centers; and allocating inventory between the first level distribution center and the second level distribution centers based on the actual replenishment levels of the products in the second level distribution centers in an upcoming replenishment operation.

### CROSS-REFERENCES

This application is a continuation-in-part application of U.S. application Ser. No. 16/208,475, filed Dec. 3, 2018,entitled “METHOD AND SYSTEM FOR RESERVING STOCK IN A REGIONAL DISTRIBUTION CENTER,” by Chenxin Ma et al., which itself is a continuation-in-part application of U.S. application Ser. No. 16/208,439, filed Dec. 3, 2018, entitled “METHOD AND SYSTEM FOR TWO-ECHELON INVENTORY ALLOCATION,” by Jie Lu et al. The entire disclosure of each of the above-identified applications is incorporated herein by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD

The present disclosure relates generally to the field of e-commerce, and more particularly to methods and systems for efficiently allocating inventory to distribution centers at different hierarchical levels.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

E-commerce has undergone a hyper growth for years and giant online retail platforms provide millions of products for customers to choose from. For a pleasant online shopping experience, the customer may expect convenient order process and fast delivery of the purchased products. To facilitate the delivery of the products, some e-commerce providers have set up distribution centers and warehouses at different locations. However, allocation of products among those distributions center is a hard task.

Therefore, an unaddressed need exists in the art to address the aforementioned deficiencies and inadequacies.

### SUMMARY

In certain aspects, the present disclosure relates to a method for allocating inventory between a first level distribution center and multiple second level distribution centers. In certain embodiments, the method includes:

for each of the second level distribution centers: determining ideal replenishment levels of products based on current inventory and demand forecast for each of the products and transportation capacity limit of the second level distribution centers;

for each of the products: determining actual replenishment levels in the second level distribution centers based on the ideal replenishment levels in the second level distribution centers, current available inventory of the product in the first level distribution center, current inventories and demand forecasts in the second level distribution centers, and priority of the second level distribution centers; and

allocating inventory from the first level distribution center to the second level distribution centers in an upcoming replenishment operation based on the actual replenishment levels of the products in the second level distribution centers.

In certain embodiments, the step of determining the ideal replenishment levels for products in one of the second level distribution centers is performed by optimizing an object function of:

min ΣᵢE(Dᵢ^{L}−Sᵢ−xᵢ)⁺ (1),

where:

Σᵢxᵢ≤M (1a),

Σᵢyᵢ≤N (1b),

xᵢ≤yᵢB ∀i (1c), and

xᵢ≥0 & xᵢ ϵ Z (1d);

where E is to take expectation value of the function (Dᵢ^{L}−Sᵢ−xᵢ)⁺; i is an index of the products in the second level distribution center being a positive integer; Dᵢ^{L} is demand forecast of an ith product in the second level distribution center in a predetermined time L; Sᵢ is a current inventory of the ith products at the second level distribution center; xᵢ is the ideal replenishment level of the ith product from the first level distribution center to the second level distribution center; yᵢ is an indication of whether ideally the ith product should be replenished or not;

where M is a maximum number of product units that the upcoming replenishment operation can deliver to the second level center; N is a maximum types of products that the upcoming replenishment operation can deliver to the second level center; and

where B is a large positive number, ∀i means for all the products in the second level distribution center, and Z is an integer.

In certain embodiments, yᵢ has a value of 0 when the xᵢ is 0, and yᵢ has a value of 1 when the xᵢ is a positive integer.

In certain embodiments, the step of determining the actual replenishment levels in the second level distribution centers is performed by optimizing an object function of:

$${min}_{{v}_{j}} {Σ}_{j} {γ}_{j} [ {E ( {D}_{j} - {S}_{j} - {v}_{j} )}^{+} ] , \qquad ( 2 )$$

where:

Σⱼvⱼ≤Q (2a),

vⱼ≤xⱼ ∀i (2b), and

vⱼ≥0 & vⱼ ϵ Z (2c),

where E is to take expectation value of the function (Dⱼ−Sⱼ−vⱼ)⁺; j is an index of the second distribution centers being a positive integer; γⱼ is a priority of the jth second level distribution center; Dⱼ is demand forecast of the products in jth second level distribution center in the predetermined time; Sⱼ is a current inventory of the product at the jth second level distribution center; vⱼ is the actual replenishment level of the product from the first level distribution center to the jth second level distribution center; xⱼ is the ideal replenishment level of the product from the first level distribution center to the jth second level distribution centers; and

where Q is a number of the product at the first level distribution center that is available for allocating to the second level distribution centers during the upcoming replenishment operation; ∀j means for the products in all of the second level distribution centers; and Z is an integer.

In certain embodiments, the predetermined time is in a range of one day to seven days. In certain embodiments, the predetermined time is two days.

In certain embodiments, j is a predetermined number in a range of 3-10. In certain embodiments, the priority of the jth second level distribution center γⱼ is in a range of 0.9-1.0.

In certain embodiments, each demand forecasts is a vector. The vector may have k dimensions, which is a distribution of the demand forecasts due to the uncertainty of the forecasts.

In certain aspects, the present disclosure relates to a system for allocating inventory between a first level distribution center and multiple second level distribution centers. In certain embodiments, the system includes a computing device. The computing device has a processor and a storage device storing computer executable code. The computer executable code, when executed at the processor, is configured to perform the method described above.

In certain aspects, the present disclosure relates to a non-transitory computer readable medium storing computer executable code. The computer executable code, when executed at a processor of a computing device, is configured to perform the method as described above.

These and other aspects of the present disclosure will become apparent from following description of the preferred embodiment taken in conjunction with the following drawings and their captions, although variations and modifications therein may be affected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment.

FIG. 1 schematically depict an example of an allocation system according to certain embodiments of the present disclosure.

FIG. 2 schematically depicts an inventory allocation system according to certain embodiments of the present disclosure.

FIG. 3 schematically depicts a two-echelon inventory allocation system according to certain embodiment of the present disclosure.

FIG. 4 schematically depicts a computing system of a two-echelon inventory allocation system according to certain embodiment of the present disclosure.

FIG. 5 schematically depicts a method of allocating inventory according to certain embodiments of the present disclosure.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present disclosure. Additionally, some terms used in this specification are more specifically defined below.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the disclosure or of any exemplified term. Likewise, the disclosure is not limited to various embodiments given in this specification.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Unless otherwise defined, “first”, “second”, “third” and the like used before the same object are intended to distinguish these different objects, but are not to limit any sequence thereof.

As used herein, “around”, “about”, “substantially” or “approximately” shall generally mean within 20 percent, preferably within 10 percent, and more preferably within 5 percent of a given value or range. Numerical quantities given herein are approximate, meaning that the term “around”, “about”, “substantially” or “approximately” can be inferred if not expressly stated.

As used herein, “plurality” means two or more.

As used herein, the terms “comprising”, “including”, “carrying”, “having”, “containing”, “involving”, and the like are to be understood to be open-ended, i.e., to mean including but not limited to.

As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure. As used herein, the term “and/or” includes any and all combinations of one or more of the associated listed items.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The term “interface”, as used herein, generally refers to a communication tool or means at a point of interaction between components for performing data communication between the components. Generally, an interface may be applicable at the level of both hardware and software, and may be uni-directional or bi-directional interface. Examples of physical hardware interface may include electrical connectors, buses, ports, cables, terminals, and other I/O devices or components. The components in communication with the interface may be, for example, multiple components or peripheral devices of a computer system.

The present disclosure relates to computer systems. As depicted in the drawings, computer components may include physical hardware components, which are shown as solid line blocks, and virtual software components, which are shown as dashed line blocks. One of ordinary skill in the art would appreciate that, unless otherwise indicated, these computer components may be implemented in, but not limited to, the forms of software, firmware or hardware components, or a combination thereof.

The apparatuses, systems and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

The present disclosure will now be described more fully hereinafter with reference to the accompanying drawings, in which embodiments of the present disclosure are shown. This disclosure may, however, be embodied in many different forms and should not be construed as limited to the embodiments set forth herein; rather, these embodiments are provided so that this disclosure will be thorough and complete, and will fully convey the scope of the present disclosure to those skilled in the art.

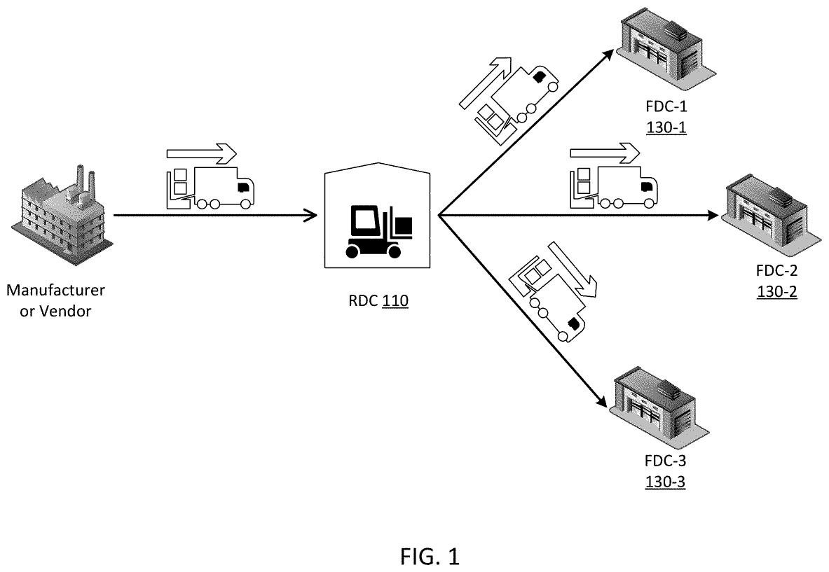

FIG. 1 schematically depict an example of an allocation system according to certain embodiments of the present disclosure. As shown in FIG. 1, the system includes a regional distribution center (RDC) 110 and several front distribution centers (FDCs) 130, e.g., FDC-1(130-1), FDC-2 (130-2) and FDC-3 (130-3). The RDC 110 is a high level distribution center that is responsible for replenishing the FDCs 130 within its coverage and the delivery of products to its associated metropolitan area and its surrounding areas. Each FDC 130 is a lower level distribution center that is responsible for the delivery to its associated metropolitan area and its surrounding areas. When the RDC 110 places an order for one SKU or product, the corresponding manufacturer or vendor ships the SKU within a vendor lead time (VLT). The RDC 110 allocates the inventory of the SKU among the RDC 110 and the FDCs 130, and transports certain amount of the SKU to the FDCs 130. In certain embodiments, the allocation is based on the demands and the inventory of the RDC 110 and the FDCs 130, and optionally the SKU price and loss information.

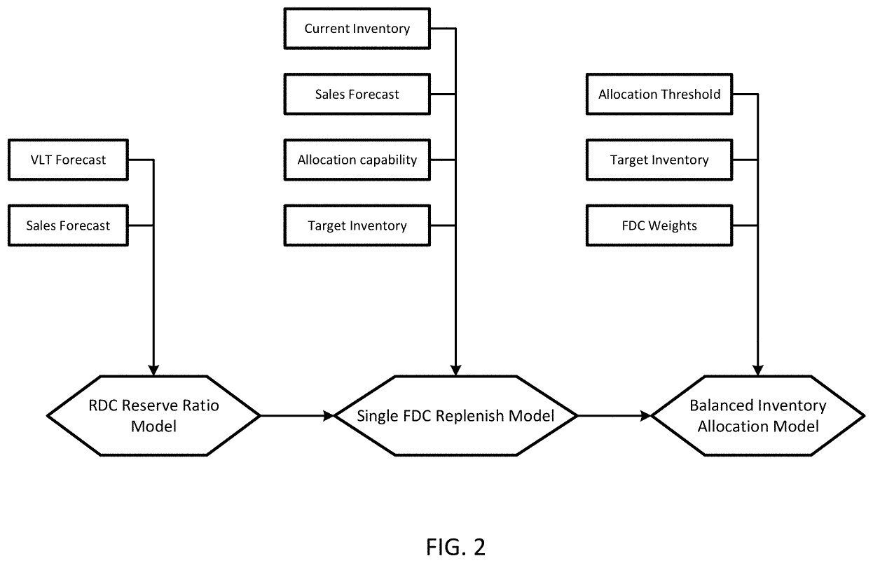

FIG. 2 schematically depicts an inventory allocation system according to certain embodiments of the present disclosure. As shown in FIG. 2, the inventory allocation system includes an RDC reserve ratio model, a single FDC replenish model, and a balanced inventory allocation model. Certain embodiments of the present disclosure defines the operation of the single FDC replenish model and the balanced inventory allocation model, when the RDC reserve ratio model has already determined the optimal reservation ratio for the products.

The RDC reserve ratio model is configured to obtain the optimal reservation ratio of an SKU in the RDC 110 based on the forecast of the VLT and sales forecast based on the VLT of the SKU. Specifically, the optimal target allocation ratio of the SKU among the RDC 110 and the FDCs 130 may be calculated based on demands and inventory of the RDC 110 and FDCs 130, SKU unit price, direct fulfilment cost for a single SKU shipped from the RDC 110 instead of from corresponding one of the FDCs 130, and the sale loss ratio incurred when using the direct fulfilment from the RDC 110 to the FDCs 130. When the RDC reserve ratio model has calculated the optimal reservation ratio of an SKU, the quantity of the SKU that can be allocated to the FDCs 130 is determined. Then the single FDC replenish model can use the quantity of the SKU in the RDC 110 for further analysis.

The single FDC replenish model is configured to determine the replenishment quantity of the SKUs in an FDC 130 based on the current inventory, the sales forecast (or demand forecast), the allocation capacity and the target inventory of the SKUs. In certain embodiments, for each FDC 130, the single FDC replenish model determines the SKUs to be replenished based on the needs of the SKU (such as the demand forecast) instead of only based on the shortage of the SKU. Further, the single FDC replenish model controls the allocation quantity within a predetermined allocation quantity level.

The balanced inventory allocation model is configured to determine the allocation of an SKU to the FDCs 130 based on the allocation threshold and target inventory of the SKU, as well as the FDC weights. The balanced inventory allocation model not only considers the priority or weights of the FDCs 130, but also ensures balanced quantity of the SKU to all the FDCs 130.

The control of the frequency and amount of inventory allocation from the RDC 110 to the FDCs 130 is a key decision in this process (note that inventory allocated to an FDC 130 usually cannot be shipped again to another FDC 130 or back to the RDC 110). Further, the inventory allocation problem has several other important: (1) The frequency of the inventory allocation is daily; (2) There is a daily transportation capacity limit on each RDC-FDC lane. The major implication of this is that the system needs to select the most urgent products to allocate in the case of insufficient transportation capacity; (3) There is a lot demand that is needed to be directly fulfilled by the RDC 110 (recall that the RDCs are associated with metropolitan cities). It is crucial that we do not over-commit the inventory to the FDCs 130 in order to avoid putting the RDC 110 itself at stockout risk; (4) The FDCs 130 are ranked by the population it covered. The business requires giving high allocation priority to the higher ranked FDCs 130.

When inventory at the RDC 110 is sufficient and transportation capacity is enough, inventory allocation decision is relatively easy as all the FDCs 130 have good chances to be replenished up to its ideal inventory level. However, the problem becomes difficult when either RDC 110 inventory or transportation capacity is insufficient. When the RDC 110 inventory is not enough to serve the needs of all the FDCs 130, the problem becomes how to allocate the limited inventory optimally in order to minimize sales loss and guarantee delivery speed promise as much as possible. When transportation capacity is insufficient, the problem becomes how to select the right products and the right amount to ship to the FDCs 130 in order to maximize allocation effectiveness.

To solve the problem described in the above embodiments, in certain aspect, the present disclosure provides a system and method to plan inventory allocation using data-driven and algorithm controlled decision. The system is termed Two-Echelon (or Two-Tier) Balance Inventory Allocation System (TEBIAS or TTBIAS). In certain embodiments, the system is provided to solve the problem after the reservation ratio of the products in the RDC 110 is predetermined for each target SKU.

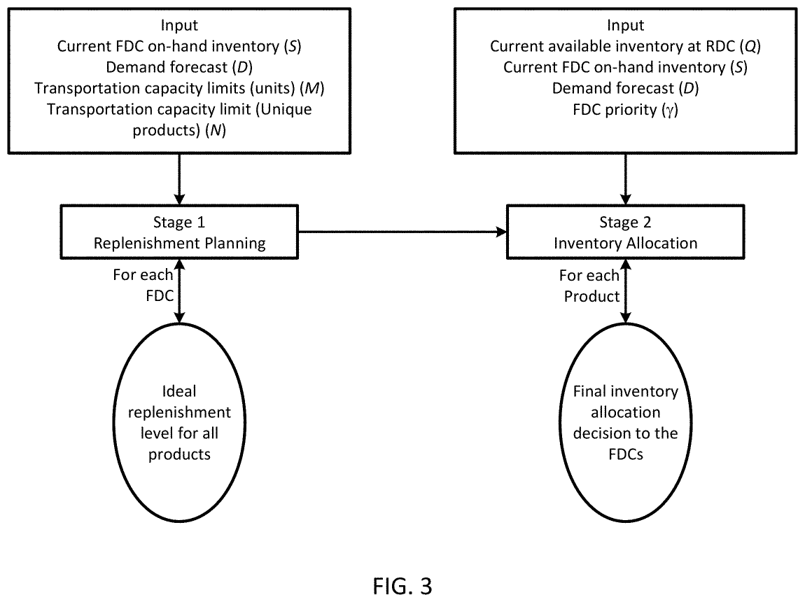

FIG. 3 schematically depicts the TEBIAS framework according to certain embodiments of the present disclosure. As shown in FIG. 3, TEBIAS applies a two-stage approach to solve the inventory allocation problem. It explicitly considers the inventory balance among the RDC 110 and the FDCs 130, as well as the transportation capacity constraints. In operation, TEBIAS collects data sets such as demand forecast, capacity settings, current inventory status, etc. Kindly note that the RDC available inventory is a key input to the system. This input is calculated by the RDC Research Stock Engine which offers the amount of inventory that can be used for allocation besides the inventory reserved at the RDC 110.

The first stage in the TEBIAS is to determine an ideal level of inventory required for all products in each single FDC 130, with the transportation capacity constraint being explicitly considered. This stage is termed the Replenishment Planning stage. The planning is performed by optimizing an object function, so as to minimize the total lost sales at the single warehouse level (FDC). The inputs of the first stage include current FDC on-hand inventory, demand forecast, transportation capacity limit of the total number of product units for the FDC for the upcoming replenishment operation, and transportation capacity limit of the total types of products for the upcoming replenishment operation. In certain embodiments, the transportation capacity limits have small variation over time, and may be the same values for a period of time such as one month. Referring to the mathematical expression in this stage shown in formula (1), this is a non-linear mixed-integer programming with the objective being minimizing the total lost sales at the single warehouse level. This problem can be very efficiently solved to optimality by first conducting some novel prepossessing and then transforming into a linear integer programming. The key of this transformation is to ensure all products holding the same service level (first order derivative equals zero) which is a necessary condition at the optimal point of the problem.

When the first stage is completed, the ideal number of SKUs needed by each FDC 130 is determined. However, the SKUs needed by the FDCs 130 may not be replenished as requested due to the limited number of the SKUs in the RDC 110. The second stage in the TEBIAS is to determine, for each product, how to allocate the limited number of available inventory at the RDC 110 to the multiple FDCs 130, given the ideal level of inventory required calculated in the Replenishment Planning stage. This stage is termed the Inventory Allocation Stage. The allocation is performed by optimizing an objective function so as to minimize the total lost sales for the target product at all FDCs 130. The inputs of this stage include current available inventory at the RDC 110, current FDC on-hand inventories and demand forecasts, and the FDC priorities. Referring to the mathematical expression in this step shown in formula (2), this is a non-linear integer programming with the objective function being minimizing the total lost sales for the target product at all FDCs 130. The parameter γⱼ indicates the priority of the FDC. Solving this problem to optimality for all products is costly in terms of the computational time. In certain embodiments, the system approximates the optimal solution with an efficient heuristic algorithm which achieves very good performance in practice. One key of the algorithm is that when available inventory at the RDC 110 is insufficient, the service level at the FDCs 130 should be proportional to the FDC priority parameter γⱼ (first order derivative equals zero). In other words, the higher ranked FDC 130 should be associated with a higher service level settings.

By performing the first stage and the second stage of the system, final inventory allocation decision is made for each product to all the FDCs 130, so that the system can instruct the delivery of appropriated number of products respectively to the FDCs 130.

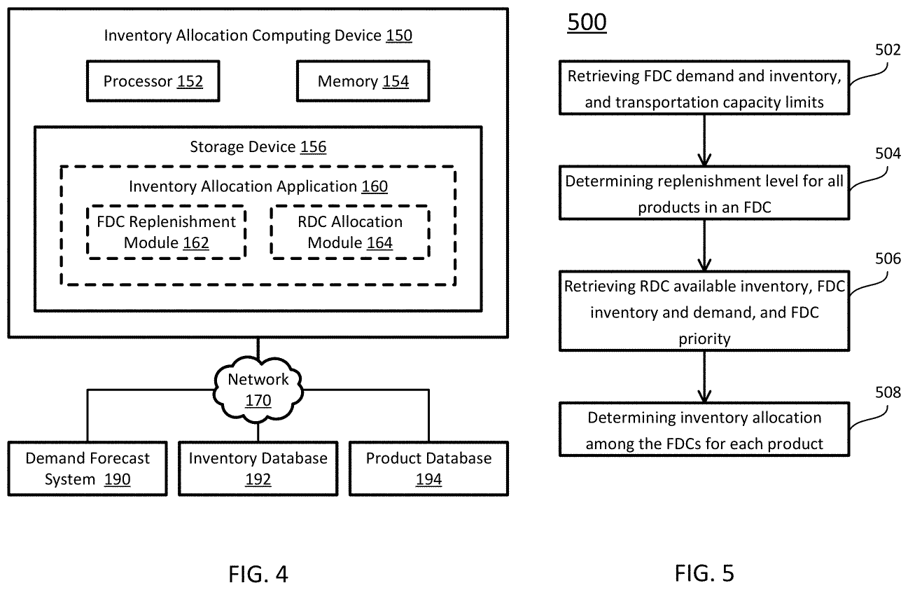

FIG. 4 schematically shows a computing system of an allocation system, where the computing systems are configured to manage the allocation between the RDC 110 and the FDCs 130. As shown in FIG. 4, the computing system of the allocation system includes an inventory allocation computing device 150, and the inventory allocation computing device 150 is in communication with, via a network 170, external data or services including a demand forecast system 190, an inventory database 192, and a product database 194. In certain embodiments, the network 170 may be a wired or wireless network, and may be of various forms. Examples of the network 170 may include, but is not limited to, a local area network (LAN), a wide area network (WAN) including the Internet, or any other type of networks. The best-known computer network is the Internet.

The inventory allocation computing device 150 is configured to implement the inventory allocation between the RDC 110 and the FDCs 130. In certain embodiments, the inventory allocation computing device 150 may be a server computer, a cluster, a cloud computer, a general-purpose computer, or a specialized computer, which can collect demand and inventory information of the RDC 110 and the FDCs 130, and transportation capacity limits, and provide practical allocation of the products from the RDC 110 to the FDCs 130.

The demand forecast system 190 may include a computing device such as a cloud computing device that provides predictions of the demands of the RDC 110 and the FDCs 130 mainly based on historical data. In certain embodiments, the demand forecast system 190 provides each SKU a daily forecast for the future time. In certain embodiments, each daily forecast may be a number of units or a range of a number of units of the SKU. For example, a daily forecast for a SKU in the next seven days may be respectively 200 units, 220 units, 280 units, 230 units, 200 units, 170 units, 190 units; or respectively 170-220 units, 200-240 units, 260-310 units, 200-260 units, 190-210 units, 170-190 units, 170-200 units. In certain embodiments, the forecast may also be a total number of units for the SKU in a predetermined time period, such as next 5 days. The daily forecast or forecast for a period of time may be a specific number of units, a specific number of units with a variance, or a distribution of numbers of units.

The inventory database 192 is stored in a computing device such as a cloud computing device that records inventory of the RDC 110 and the FDCs 130 and optionally other inventory related information and analysis.

The product database 194 is stored in a computing device such as a cloud computing device that provides product information. Each product has an SKU as identification. The product information of an SKU may include the identification of the product (i.e., the SKU), the category of the product, the name or title of the product, the dimensions and weight of a unit of the product, the color of the product, the unit price of the product, the direct fulfilment cost for the product shipped from the RDC 110 to the FDCs 130, the sale loss ratio incurred for the product when using the direct fulfilment from RDC 110 to the FDCs 130 (or to the customers covered by the FDCs 130). Because each specific product has a corresponding SKU, product and SKU may be used interchangeably in this disclosure.

Those information in the demand forecast system 190, the inventory database 192, and the product database 194 are accessible to the inventory allocation computing device 150.

As shown in FIG. 4, the inventory allocation computing device 150 may include, without being limited to, a processor 152, a memory 154, and a storage device 156. In certain embodiments, the inventory allocation computing device 150 may include other hardware components and software components (not shown) to perform its corresponding tasks. Examples of these hardware and software components may include, but not limited to, other required memory, interfaces, buses, Input/Output (I/O) modules or devices, network interfaces, and peripheral devices. In certain embodiments, the inventory allocation computing device 150 is a cloud computer or a server computer, and the processor 152, the memory 154 and the storage device 156 are shared resources provided over the Internet on-demand.

The processor 152 may be a central processing unit (CPU) which is configured to control operation of the inventory allocation computing device 150. The processor 152 can execute an operating system (OS) or other applications of the inventory allocation computing device 150. In some embodiments, the inventory allocation computing device 150 may have more than one CPU as the processor, such as two CPUs, four CPUs, eight CPUs, or any suitable number of CPUs.

The memory 154 can be a volatile memory, such as the random-access memory (RAM), for storing the data and information during the operation of the inventory allocation computing device 150. In certain embodiments, the memory 154 may be a volatile memory array. In certain embodiments, the inventory allocation computing device 150 may run on more than one memory 154.

The storage device 156 is a non-volatile data storage media for storing the OS (not shown) and other applications of the inventory allocation computing device 150. Examples of the storage device 156 may include non-volatile memory such as flash memory, memory cards, USB drives, hard drives, floppy disks, optical drives, or any other types of data storage devices. In certain embodiments, the inventory allocation computing device 150 may have multiple storage devices 156, which may be identical storage devices or different types of storage devices, and the applications of the inventory allocation computing device 150 may be stored in one or more of the storage devices 156 of the inventory allocation computing device 150. As shown in FIG. 4, the storage device 156 includes an inventory allocation application 160 (“Application”). The inventory allocation application 160 provides a system to collect product inventory, product demand, and transportation limit, and provide allocation instructions that optimizes product distribution. In certain embodiments, the inventory allocation application 160 is performed regularly, such as daily before delivery of products from the RDC 110 to the FDCs 130. For each time of updating, inventory allocation application 160 is configured to retrieve most current data or most recent historical data. In certain embodiments, the inventory allocation application 160 is able to perform one round of computation in minutes. In certain embodiments, the inventory allocation application 160 is programed to run once a day at a predetermined time. The inventory allocation application 160, by daily updating the processed data, provides nearly real time distribution arrangement.

As shown in FIG. 4, the inventory allocation application 160 includes, among other things, an FDC replenishment module 162 and an RDC allocation module 164. In certain embodiments, the inventory allocation application 160 may include other applications or modules necessary for the operation of the modules 162 and 164. It should be noted that the modules are each implemented by computer executable codes or instructions, or data table or databases, which collectively forms one application. In certain embodiments, each of the modules may further include sub-modules. Alternatively, some of the modules may be combined as one stack. In other embodiments, certain modules may be implemented as a circuit instead of executable code. In certain embodiments, some of the modules of the inventory allocation application 160 may be located at a remote computing device, and the modules of the inventory allocation application 160 in the local computing device 150 communicate with the modules in the remote computing device via a wired or wireless network. In certain embodiments, the inventory allocation computing device 150 is a cloud computer server.

The FDC replenishment module 162 is configured to, when the inventory allocation application 160 is in operation, retrieve the current FDC inventories for each of the SKUs in one specific FDC 130 and the demand forecast for each of the SKUs in the FDC 130 during a predetermined future time, obtain the transportation capacity limits (units) M and the transportation capacity limit (unique products) N for the FDC 130, use those retrieved data to calculate SKUs to be replenished and the number of units for the SKUs to be replenished in the FDC 130, and send those calculated result to the RDC inventory allocation model 164.

The FDC replenishment module 162 is aimed to perform the above calculations on each of the FDCs 130. In certain embodiments, the FDC replenishment module 162 is configured to retrieve the inventory of each of the SKUs in the specific FDC 130 from the inventory database 192, and retrieve the demand forecast for each of the SKUs in the FDC 130 during the predetermined future time from the demand forecast system 190. In certain embodiments, the predetermined future time (or predetermined time) is in a range of 1 day to 1 week. In certain embodiments, the predetermined time is determined based on the frequency of the replenishment and the time needed for completing the replenishment on the road. In one embodiment, the replenishment frequency is daily and the on route time for the replenishment is 1 day, and the predetermined time may be set as 1 day. In one embodiment, the replenishment frequency is daily and the on route time for the replenishment is 2 days, and the predetermined time may be set as 2 days. In one embodiment, the replenishment frequency is daily and the on route time for the replenishment is 1 day, but the predetermined time may be set as 2 days to compensate uncertainty of sales of the products and uncertainty of the on route time for the replenishment. In one embodiment, the replenishment frequency is daily and the on route time for the replenishment is 2 days, but the predetermined time may be set as 3 days to compensate uncertainty of sales of the products and uncertainty of the on route time for the replenishment.

In certain embodiments, the FDC replenishment module 162 is configured to obtain the transportation capacity limits M and N from a manager of the inventory allocation computing device 150 (the manager may enter the values of M and N via an interface), or receive the values M and N from other departments or services, such as from the replenishment operation department or from each of the FDCs 130. The transportation capacity limits M is the total number of units that the upcoming replenishment operation can deliver, and the transportation capacity limits N is the total types of products that the upcoming replenishment operation can deliver. The limit M may also be termed maximum transportation units and the limit N may also be termed maximum transportation SKU types in the disclosure for convenience. In certain embodiments, the limits M and N for different FDCs 130 may be different. In certain embodiments, the limits M and N for one FDC 130 are proportional to an overall demand of region associated to that FDC 130.

After obtaining those information, the FDC replenishment module 162 is configured to minimize an object function (1) using those obtained data:

min Σᵢ E(Dᵢ^{L}−Sᵢ−xᵢ)⁺ (1).

For the object function of formula (1), the FDC replenishment module 162 looks for a minimum expected value of the summation of the calculation of all the SKUs in one of the FDCs 130. In formula (1), for one FDC 130, E is to take expectation value; i is an index of SKUs in that FDC 130, and is a positive integer selected from a range of 1 to I, where I is the total number of SKUs in the FDC 130; Dᵢ^{L} is demand forecast of the ith SKU in the FDC 130 in the predetermined time L, L may be as described above 1 to 2 days or more; Sᵢ is the current inventory of the ith SKU in the FDC 130; xᵢ is the expected replenishment quantity of the ith SKU from the RDC 110 to the FDC 130, where the quantity may be the number of units of the ith SKU; and + means that the summation is only performed to the (Dᵢ^{L}−Sᵢ−xᵢ) when it is positive, and when the (Dᵢ^{L}−Sᵢ−xᵢ) for one of the ith SKU is negative, the value of that (Dᵢ^{L}−Sᵢ−xᵢ) is discarded from the summation operation or set as 0. For example, some of the SKUs in the FDC 130 has plenty of inventory Sᵢ, and the SKUs' (Dᵢ^{L}−Sᵢ−xᵢ) are negative, then there is no need to deliver more of those SKUs to the FDC 130, and the negative values of the (Dᵢ^{L}−Sᵢ−xᵢ) corresponding to those SKUs are not considered (or are discarded, or set as 0) in the object function.

For the optimization of the object function (1), the FDC replenishment module 162 is further configured to define the parameters in the object function as follows:

s.t. Σᵢxᵢ≤M (1a),

Σᵢyᵢ≤N (1b),

xᵢ≤yᵢB ∀i (1c), and

xᵢ≥0 & xᵢ ϵ Z (1d).

s.t. means “such that.” The formula (1a) defines a total capacity limit M for the FDC 130, that is, the total number of units of products that the upcoming replenishment operation can provide. Since xᵢ represents the expected replenishment quantity of one of the SKUs from the RDC 110 to the FDC 130, the summation of all the replenished quantity of all the SKUs is less than the limit M. When the value of xᵢ for a specific product in the FDC 130 is 0, that product will not be replenished during the upcoming replenishment operation. In other words, in the total SKUs in the FDC 130, some of the SKUs have a positive integer value of xᵢ, and will be replenished by the xᵢ units; some of the SKUs have a value of 0 for their respective xᵢ, and will not be replenished.

Further, the formula (1b) defines a total capacity limit N for the FDC 130 which is the maximal number of SKUs a replenishment would handle. In other words, the coming replenishment cannot deliver more than N types of SKUs. Here yᵢ is 1 when the corresponding SKU is included in the replenishment, and yᵢ is 0 when the corresponding SKU is not included in the replenishment.

In addition, as shown by formula (1c), B is a large positive integer or a large positive real number, for example 10,000 or 100,000. By this constraint, when the SKU is included in the replenishment, the corresponding yᵢ is 1, and the number of units of the SKU xᵢ is less than a very large number; and when the SKU is not included in the replenishment, the corresponding yᵢ is 0, and the number of units of the SKU xᵢ equals to 0. This constraint establishes the relationship between the number of units of the SKUs and the number of types of the SKUs.

Moreover, as shown in formula (1d), the constraint for the number of units of the SKU xᵢ to be replenished is that xᵢ equals to or greater than 0 and is an integer.

After the minimization of the object function for one FDC 130, the replenish quantity and types of the SKUs in that FDC 130 is determined. The minimization of the object functions is then performed on each of the FDCs 130, and the FDC replenishment module 162 is further configured to send those information to the RDC allocation module 164. The information sent by the FDC replenishment module 162 to the RDC allocation module 164 at least includes the ideal replenishment levels of all the product in each of the related FDCs 130. In certain embodiments, the information may be arranged in two parts, an FDC replenishment product list and the ideal replenish levels of the products in the list relative to each of the FDCs 130. Table 1 shows an example of the information the FDC replenishment module 162 sent to the RDC allocation module 164. As shown in Table 1, there are a total of P SKUs that need to be replenished based on the calculation in stage 1. Kindly note not all P SKUs are required by each of the FDCs 130. In other words, some of the SKUs in the P SKUs are needed by one FDC 130 or some FDCs 130, while some other SKUs in the P SKUs are needed by the other FDC 130 or some other FDCs 130. There are a total of J number of FDCs that at least needs replenishment of at least one SKU. For the SKU 1127 (identification of the product), the ideal replenishment of the product in the FDC-1, FDC-2 and FDC-J are 60 units, 0 units, and 30 units respectively. Therefore, the FDC-2 does not need to replenish the SKU 1127.

| SKU/FDC | | | | |
|---|---|---|---|---|
| ideal replenishment | FDC-1 | FDC-2 | . . . | FDC-J |
| 1008 | 108 | 33 | . . . | 50 |
| 1127 | 60 | 0 | . . . | 30 |
| 1139 | 125 | 86 | . . . | 35 |
| 2006 | 287 | 100 | . . . | 0 |
| . . . | . . . | . . . | . . . | . . . |
| P | 31 | 72 | . . . | 90 |

The RDC allocation module 164 is configured to, upon receiving the ideal replenishment level for the products in the FDCs 130 from the FDC replenishment module 162, retrieve the available inventory at the RDC 110, retrieve the current FDC inventories for the products to be replenished, retrieve the demand forecast for the products to be replenished, and obtain FDC priority, so as to get final inventory allocation decision to the FDCs 130.

The RDC allocation module 164 is aimed to perform the above calculations on each of the products. In certain embodiments, when the FDC replenishment module 162 sends an ideal replenishment level for the products to the RDC allocation module 164, there may be a product list that lists products having their ideal replenishment levels. The products that do not need to be replenished are not included in the list. By combining the product lists from all the FDCs 130, an FDC replenishment product list (a combined list) can be obtained. Each product in the FDC replenishment product list is at least listed by one of the FDCs 130 that the product needs to be replenished. Each of the products in the FDC replenishment product list may be requested by several different FDCs 130, for example the SKU 2006 in Table 1 is requested by the FDC-1 and FDC-2, but not by the FDC-J. The RDC allocation module 164 is configured to process the products in this FDC replenishment product list. For each of the products in the FDC replenishment product list, the RDC allocation module 164 is configured to allocate the products to the associated FDCs 130 only. For example, when the RDC allocation module 164 re-allocate the SKU 2006 according to Table 1, it only decide the allocation of the SKU 2006 from the RDC 110 to the FDC-1 and FDC-2, but not to the FDC-J, because the FDC-J does not need to replenish the SKU 2006 and thus is not associated with the SKU 2006 in the upcoming replenishment.

For each product in the FDC replenishment product list, the RDC allocation module 164 is configured to retrieve the current available inventory Q at RDC 110 from the inventory database 192, or from a module at the storage device 156 that calculates the current available inventory Q. The current available inventory Q is the units of the product in the RDC 110 that can be distributed to the FDCs 130. The rest of the inventory of the product is reserved in the RDC 110.

Further, for each product in the FDC replenishment product list, the RDC allocation module 164 is configured to retrieve the current FDC on-hand inventories S of the product in each of the FDCs 130 from the inventory database 192.

Furthermore, for each product in the FDC replenishment product list, the RDC allocation module 164 is configured to retrieve the demand forecast D of the product in each of the FDCs 130 from the demand forecast system 190 in the predetermined time. In certain embodiments, the FDC replenishment module 162 may provide those demands forecast so that the RDC allocation module 164 does not have to retrieve those demands information again.

Moreover, the RDC allocation module 164 is configured to obtain an FDC priority γ for each of the FDCs 130. The FDC priority may be a predetermined value provided by the manager of the system, or retrieved from other services. In certain embodiments, the FDCs 130 are equally weighted and the FDC priority for all the FDCs 130 is set as 1. In certain embodiments, based on the FDC area information, such as population, transportation convenience, sale history, the FDC priority is set at a value from 0.8-1.0, and preferably between 0.9-1.0 The more important the FDC, the higher the priority value.

After obtaining the above information, the RDC allocation module 164 is configured to minimize an object function (2) using the obtained data:

$${min}_{{v}_{j}} {Σ}_{j} {γ}_{j} [ {E ( {D}_{j} - {S}_{j} - {v}_{j} )}^{+} ] . \qquad ( 2 )$$

For the object function of formula (2), the RDC allocation module 164 looks for a minimum value of the summation of weighted expectation of each product in different FDCs 130. By this optimization for each of the products in the FDC replenishment product list, the RDC allocation module 164 is configured to achieve balanced distribution of each specific product to different FDCs 130. The formula (2) is a function aimed on one specific product, and in the formula (2), E is to take expectation value; j is an index of the FDCs 130, there are a total number of J FDCs 130, J is a positive integer, and j is selected from the positive integers from 1 to J; γⱼ is the FDC priority of the jth FDC 130; Dⱼ is the demand of the specific product in the jth FDC 130 in the predetermined time; Sⱼ is the current inventory of the specific product in the jth FDC 130; vⱼ is the upcoming replenishment units of the specific product to the jth FDC 130; and + means that the summation is only performed to the (Dⱼ−Sⱼ−vⱼ) when it is positive, and when the (Dⱼ−Sⱼ−vⱼ) for the jth FDC 130 is negative, the value of that (Dⱼ−Sⱼ−vⱼ) is discarded from the summation operation or set as 0. For example, an FDC 130 may have plenty of inventory Sⱼ, and the specific SKU's (Dⱼ−Sⱼ−vⱼ) is negative, then there is no need to deliver more of the SKU to that FDC 130, and the negative values of the (Dⱼ−Sⱼ−vⱼ) corresponding to the SKU is not considered (or is discarded, or set as 0) in the object function.

For the optimization of the object function (2), the RDC allocation module 164 is further configured to define the parameters in the object function as follows:

s.t. Σⱼvⱼ≤Q (2a),

vⱼ≤xⱼ∀i (2b), and

vⱼ≥0 & vⱼ ϵ Z (2c).

s.t. means “such that.” The formula (2a) defines that a total allocation units of the specific product to the J FDCs 130 should equals to or less than Q, where Q is the number of unit of that product in the RDC 110 that is available for allocation.

Further, the formula (2b) defines that the real allocation quantity of the specific product to the jth FDC 130 equals to or is less than the ideal replenishment level of that product in the jth FDC calculated in the first stage. Here xⱼ is the xᵢ calculated in the first stage for the jth FDC.

In addition, as shown by formula (2c), the constraint for the number of allocated units of the specific SKU to the jth FDC is 0 or a positive integer.

The object function of the formula (2) is performed for one SKU, and repeated for all the SKUs in the FDC replenishment product list. Therefore, a final result of the object function of the formula (2) provides allocation of each of the SKUs to be actually replenished, to each of the J FDCs 130.

FIG. 5 depicts a method for inventory allocation according to certain embodiments of the present disclosure. In certain embodiments, a method 500 is implemented by the inventory allocation computing device 150 shown in FIG. 4. It should be particularly noted that, unless otherwise stated in the present disclosure, the steps of the method may be arranged in a different sequential order, and are thus not limited to the sequential order as shown in FIG. 5. Some detailed description which has been discussed previously may be omitted here for simplicity.

As shown in FIG. 5, at procedure 502, for all SKUs or products having the SKUs in one FDC 130, the FDC replenishment module 162 retrieves the current on-hand inventories S for all the SKUs from the inventory database 192, retrieves the demand forecast D in a predetermined time for all the SKUs from the demand forecast system 190, and obtains the transportation capacity limits (units) M and transportation capacity limits (unique products) N from an input from a manager of the inventory allocation system or from the corresponding FDC 130 or from an external service. The predetermined time may be the current time to the next replenishment time of the FDC 130, or a time one or two days longer than the period from the current time to the next replenishment time of the FDC 130. In certain embodiments, the predetermined time is one or two days. The transportation capacity limit M is the maximum number of units that the upcoming replenishment operation can delivery to the FDC 130; and the transportation capacity limit N is the maximum types of the SKUs that the upcoming replenishment operation can delivery to the FDC 130.

Then at procedure 504, the FDC replenishment module 162 optimizes the object function of formula (1) using the above retrieved or obtained data of all the SKUs in the FDC 130. After the optimization, the FDC replenishment module 162 determines the ideal replenishment level for each of the SKUs in the FDC 130 that needs to be replenished.

By repeating the procedures 502 and 504 for each of the FDCs 130, the ideal replenishment level for all the SKUs in each of the FDCs 130 are obtained. Kindly note during the repetition of the procedures 502 and 504 for each FDC 130, the FDC replenishment module 162 may not need to obtain the transportation capacity limits M and N each time if the limits M and N are the same for all the FDCs. But if the transportation capacity limits M and N are different for different FDCs 130, the FDC replenishment module 162 needs to obtain those different Ms and Ns. In certain embodiments, the FDC replenishment module 162 may obtain those different Ms and Ns together as a batch, and does not need to retrieve those values separately.

In certain embodiments, after obtaining the ideal replenishment level for all products in each of the FDCs 130, the FDC replenishment module 162 may combine those result in a format such as shown in Table 1. In certain embodiments, the combined result may include the FDC replenishment product list corresponding to all the products that need to be replenished in any one of the FDCs 130, and the ideal replenishment level of the products in the list for one or more FDCs 130. The FDC replenishment module 162 then sends the product list and the ideal replenishment level(s) of each product in the list to the RDC allocation module 164, where the product list constraints the number of products that the RDC allocation module 164 need to analyze, and the ideal replenishment levels of the products constraint the maximum of the actual replenishments of the products can be.

At procedure 506, upon receiving the list of products and the ideal replenish levels of the products, the RDC allocation module 164 processes those products separately. Specifically, for each product, the RDC allocation module 164 obtains the current available inventory at RDC for the product, obtains the current FDC inventories of the product in different FDCs 130 that require that product, obtains the demand forecasts of the product in the predetermined time in different FDCs 130 that require that product, and obtains FDC priority, and those data can be used to obtain allocation of the product among different FDCs 130 that require that product.

In certain embodiments, the RDC allocation module 164 obtains the current available inventory at the RDC 110 for the product from a reservation ratio module of the storage device 156, which provides an optimal ratio of the products in the RDC 110 that is available for being distributed to the FDCs 130. The ratio times the total unit number of the product in the RDC 110 gives the current available inventory Q at the RDC 110.

In certain embodiments, the RDC allocation module 164 obtains the current FDC inventories of the product in different FDCs 130 that require that product from the inventory database 192. In certain embodiments, the RDC allocation module 164 may also obtain the current FDC inventories of the product from the FDC replenishment module 162 because the FDC replenishment module 162 has already retrieved those data.

In certain embodiments, the RDC allocation module 164 obtains the demand forecasts of the product in different FDCs 130 that require that product from the demand forecast system 190. In certain embodiments, the RDC allocation module 164 may also obtain the demand forecasts of the product from the FDC replenishment module 162 because the FDC replenishment module 162 has already retrieved those data.

In certain embodiments, the RDC allocation module 164 obtains the FDC priority from inputs by a manager of the allocation system or from an external source. In certain embodiments, the FDC priority is the same, such as 1.0 for all the FDCs; in certain embodiments, the FDC priority for each FDC is a predetermined number in a range of 0.8-1.0, preferably in a range of 0.9-1.0, based on the importance of the FDCs. The FDCs having more population may have higher priorities, and the FDCs having less population may have lower priorities.

At procedure 508, after obtaining all the above data, the RDC allocation module 164 uses those data to optimize the object function of the formula (2), so as to obtain allocations of the product among different FDCs 130 that require that product.

The RDC allocation module 164 repeats the procedures 506 and 508 for each product from the list. After allocating each product to corresponding FDCs 130, the result are used to instruct the upcoming replenishment operation.

In certain embodiments, for each product in an FDC 130, the final allocation equals to or is less than the ideal allocation, the total number of final allocations of the SKUs need to be replenished in the FDC 130 is likely less than the total number of ideal allocations of the SKUS need to be replenished in the FDC 130. To compensate the differences between the two total numbers, in certain embodiments, the limits M and N may be increased by a small number, such as increased by 1-10%, preferably 2%.

In a further aspect, the present invention is related to a non-transitory computer readable medium storing computer executable code. The code, when executed at a processer of a computing device, may perform the method 500 as described above. In certain embodiments, the non-transitory computer readable medium may include, but not limited to, any physical or virtual storage media. In certain embodiments, the non-transitory computer readable medium may be implemented as the storage device 156 of the inventory allocation computing device 150 as shown in FIG. 4.

In certain embodiments, the advantages of the TEBIAS includes, among other things: (1) TEBIAS balances inventory among the FDCS in order to minimize total sales loss; (2) TEBIAS takes care of the priorities of the FDCs properly (not over protect high ranked FDCs); (3) TEBIAS explicitly considers the transportation capacity limits to avoid overtime workload.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A method for allocating inventory between a first level distribution center and a plurality of second level distribution centers, the method comprising:
for each of the second level distribution centers: determining ideal replenishment levels of products based on current inventory and demand forecast for each of the products and transportation capacity limit of the second level distribution centers;
for each of the products: determining actual replenishment levels in the second level distribution centers based on the ideal replenishment levels in the second level distribution centers, current available inventory of the product in the first level distribution center, current inventories and demand forecasts in the second level distribution centers, and priority of the second level distribution centers; and
allocating inventory from the first level distribution center to the second level distribution centers in an upcoming replenishment operation based on the actual replenishment levels of the products in the second level distribution centers.

2. The method of claim 1, wherein the step of determining the ideal replenishment levels for products in one of the second level distribution centers is performed by optimizing an object function of:
min ΣᵢE(Dᵢ^{L}−Sᵢ−xᵢ)⁺ (1),
wherein:
Σᵢxᵢ≤M (1a),
Σᵢyᵢ≤N (1b),
xᵢ≤yᵢB ∀i (1c), and
xᵢ≥0 & xᵢ ϵ Z (1d),
wherein E is to take expectation value of the function (Dᵢ^{L}−Sᵢ−xᵢ)⁺;i is an index of the products in the second level distribution center being a positive integer; Dᵢ^{L} is demand forecast of an ith product in the second level distribution center in a predetermined time L; Sᵢ is a current inventory of the ith products at the second level distribution center; xᵢ is the ideal replenishment level of the ith product from the first level distribution center to the second level distribution center; yᵢ is an indication of whether ideally the ith product should be replenished or not;
wherein M is a maximum number of product units that the upcoming replenishment operation can deliver to the second level center; N is a maximum types of products that the upcoming replenishment operation can deliver to the second level center; and
wherein B is a large positive number, ∀i means for all the products in the second level distribution center, and Z is an integer.

3. The method of claim 2, wherein yᵢ has a value of 0 when the xᵢ is 0, and yᵢ has a value of 1 when the xᵢ is a positive integer.

4. The method of claim 2, wherein the step of determining the actual replenishment levels in the second level distribution centers is performed by optimizing an object function of:
$${min}_{{v}_{j}} {Σ}_{j} {γ}_{j} [ {E ( {D}_{j} - {S}_{j} - {v}_{j} )}^{+} ] , \qquad ( 2 )$$
wherein:
Σⱼvⱼ≤Q (2a),
vⱼ≤xⱼ∀i (2b), and
vⱼ≥0 & vⱼ ϵ Z (2c),
wherein E is to take expectation value of the function (Dⱼ−Sⱼ−vⱼ)⁺; j is an index of the second distribution centers being a positive integer; γⱼ is a priority of the jth second level distribution center; Dⱼ is demand forecast of the products in jth second level distribution center in the predetermined time; Sⱼ is a current inventory of the product at the jth second level distribution center; vⱼ is the actual replenishment level of the product from the first level distribution center to the jth second level distribution center; xⱼ is the ideal replenishment level of the product from the first level distribution center to the jth second level distribution centers; and
wherein Q is a number of the product at the first level distribution center that is available for allocating to the second level distribution centers during the upcoming replenishment operation; ∀ⱼ means for the products in all of the second level distribution centers; and Z is an integer.

5. The method of claim 4, wherein the predetermined time is in a range of one day to seven days.

6. The method of claim 5, wherein the predetermined time is two days.

7. The method of claim 4, wherein j is in a range of 3-10.

8. The method of claim 4, wherein the priority of the jth second level distribution center γⱼ is in a range of 0.9-1.0.

9. The method of claim 1, wherein each of the demand forecasts is a vector.

10. A system for allocating inventory between a first level distribution center and a plurality of second level distribution centers, the system comprising a computing device, the computing device comprising a processor and a storage device storing computer executable code, wherein the computer executable code, when executed at the processor, is configured to:
for each of the second level distribution centers: determine ideal replenishment levels of products based on current inventory and demand forecast for each of the products and transportation capacity limit of the second level distribution centers;
for each of the products: determine actual replenishment levels in the second level distribution centers based on the ideal replenishment levels in the second level distribution centers, current available inventory of the product in the first level distribution center, current inventories and demand forecasts in the second level distribution centers, and priority of the second level distribution centers; and
allocate inventory from the first level distribution center to the second level distribution centers in an upcoming replenishment operation based on the actual replenishment levels of the products in the second level distribution centers.

11. The system of claim 10, wherein the computer executable code is configured to determine the ideal replenishment levels for products in one of the second level distribution centers by optimizing an object function of:
min Σᵢ E(Dᵢ^{L}−Sᵢ−xᵢ)⁺ (1),
wherein
Σᵢxᵢ≤M (1a),
Σᵢyᵢ≤N (1b),
xᵢ≤yᵢB ∀i (1c), and
xᵢ≥0 & xᵢ ϵ Z (1d);
wherein E is to take expectation value of the function (Dᵢ^{L}−Sᵢ−xᵢ)⁺; i is an index of the products in the second level distribution center being a positive integer; Dᵢ^{L} is demand forecast of an ith product in the second level distribution center in a predetermined time L; Sᵢ is a current inventory of the ith products at the second level distribution center; xᵢ is the ideal replenishment level of the ith product from the first level distribution center to the second level distribution center; yᵢ is an indication of whether ideally the ith product should be replenished or not;
wherein M is a maximum number of product units that the upcoming replenishment operation can deliver to the second level center; N is a maximum types of products that the upcoming replenishment operation can deliver to the second level center; and
wherein B is a large positive number, ∀i means for all the products in the second level distribution center, and Z is an integer.

12. The system of claim 11, wherein yᵢ has a value of 0 when the xᵢ is 0, and yᵢ has a value of 1 when the xᵢ is a positive integer.

13. The system of claim 11, wherein the computer executable code is configured to determine the actual replenishment levels in the second level distribution centers by optimizing an object function of:
$${min}_{{v}_{j}} {Σ}_{j} {γ}_{j} [ {E ( {D}_{j} - {S}_{j} - {v}_{j} )}^{+} ] , \qquad ( 2 )$$
wherein
Σⱼvⱼ≤Q (2a),
vⱼ≤xⱼ ∀i (2b), and
vⱼ≥0 & vⱼ ϵ Z (2c);
wherein E is to take expectation value of the function (Dⱼ−Sⱼ−vⱼ)⁺; j is an index of the second distribution centers being a positive integer; γⱼ is a priority of the jth second level distribution center; Dⱼ is demand forecast of the products in jth second level distribution center in the predetermined time; Sⱼ is a current inventory of the product at the jth second level distribution center; vⱼ is the actual replenishment level of the product from the first level distribution center to the jth second level distribution center; xⱼ is the ideal replenishment level of the product from the first level distribution center to the jth second level distribution centers; and
wherein Q is a number of the product at the first level distribution center that is available for allocating to the second level distribution centers during the upcoming replenishment operation; ∀j means for the products in all of the second level distribution centers; and Z is an integer.

14. The system of claim 13, wherein the predetermined time is in a range of one day to seven days.

15. The system of claim 14, wherein the predetermined time is two days.

16. The system of claim 13, wherein j is in a range of 3-10, and the priority of the jth second level distribution center γⱼ is in a range of 0.9-1.0.

17. A non-transitory computer readable medium storing computer executable code, wherein the computer executable code, when executed at a processor of a computing device, is configured to:
for each second level distribution centers: determine ideal replenishment levels of products based on current inventory and demand forecast for each of the products and transportation capacity limit of the second level distribution centers;
for each of the products: determine actual replenishment levels in the second level distribution centers based on the ideal replenishment levels in the second level distribution centers, current available inventory of the product in the first level distribution center, current inventories and demand forecasts in the second level distribution centers, and priority of the second level distribution centers; and
allocate inventory from the first level distribution center to the second level distribution centers in an upcoming replenishment operation based on the actual replenishment levels of the products in the second level distribution centers.

18. The non-transitory computer readable medium of claim 17, wherein the computer executable code is configured to determine the ideal replenishment levels for products in one of the second level distribution centers by optimizing an object function of:
min ΣᵢE(Dᵢ^{L}−Sᵢ−xᵢ)⁺ (1),
wherein
Σᵢxᵢ≤M (1a),
Σᵢyᵢ≤N (1b),
xᵢ≤yᵢB ∀i (1c), and
xᵢ≥0 & xᵢ ϵ Z (1d);
wherein E is to take expectation value of the function (Dᵢ^{L}−Sᵢ−xᵢ)⁺; i is an index of the products in the second level distribution center being a positive integer; Dᵢ^{L} is demand forecast of an ith product in the second level distribution center in a predetermined time L; Sᵢ is a current inventory of the ith products at the second level distribution center; xᵢ is the ideal replenishment level of the ith product from the first level distribution center to the second level distribution center; yᵢ is an indication of whether ideally the ith product should be replenished or not;
wherein M is a maximum number of product units that the upcoming replenishment operation can deliver to the second level center; N is a maximum types of products that the upcoming replenishment operation can deliver to the second level center; and
wherein B is a large positive number, ∀i means for all the products in the second level distribution center, and Z is an integer.

19. The non-transitory computer readable medium of claim 18, wherein yᵢ has a value of 0 when the xᵢ is 0, and yᵢ has a value of 1 when the xᵢ is a positive integer.

20. The non-transitory computer readable medium of claim 18, wherein the computer executable code is configured to determine the actual replenishment levels in the second level distribution centers by optimizing an object function of:
$${min}_{{v}_{j}} {Σ}_{j} {γ}_{j} [ {E ( {D}_{j} - {S}_{j} - {v}_{j} )}^{+} ] , \qquad ( 2 )$$
wherein
Σⱼvⱼ≤Q (2a),
vⱼ≤xⱼ ∀i (2b), and
vⱼ≥0 & vⱼ ϵ Z (2c),
wherein E is to take expectation value of the function (Dⱼ−Sⱼ−vⱼ)⁺; j is an index of the second distribution centers being a positive integer; γⱼ is a priority of the jth second level distribution center; Dⱼ is demand forecast of the products in jth second level distribution center in the predetermined time; Sⱼ is a current inventory of the product at the jth second level distribution center; vⱼ is the actual replenishment level of the product from the first level distribution center to the jth second level distribution center; xⱼ is the ideal replenishment level of the product from the first level distribution center to the jth second level distribution centers; and
wherein Q is a number of the product at the first level distribution center that is available for allocating to the second level distribution centers during the upcoming replenishment operation; ∀j means for the products in all of the second level distribution centers; and Z is an integer.
